(19) United States
(12) Patent Application Publication
(10) Pub. No.: US 2026/0098208 A1
(43) Pub. Date: Apr. 9, 2026

(54) NUTRITIONAL SOIL CONDITIONING AGENT

(71) Applicant: Clayton Julian Postma, Gordon's Bay (ZA)

(72) Inventor: Clayton Julian Postma, Gordon's Bay (ZA)

(21) Appl. No.: 19/113,902

(22) PCT Filed: Sep. 21, 2023
(86) PCT No.: PCT/ZA2023/050058

§ 371 Date: Mar. 20, 2025

(30) Foreign Application Priority Data
Sep. 22, 2022 (ZA) 2022/10496

(51) Int. Cl. C09K 17/50; C09K 101/00

(52) U.S. Cl. CPC C09K 17/50; C09K 2101/00

(57) ABSTRACT

A pelletized nutritional soil conditioning formulation which includes particulates of igneous rock; particulates of a carbon source; and a binding agent to bind together the particulates of igneous rock and the carbon source.

### FIELD OF THE INVENTION

This invention relates generally to a composition that conditions the soil, improving parameters such as water retention, microbial density and diversity, nutrient content, and structure.

### BACKGROUND OF THE INVENTION

Rapid population growth coupled with unsustainable agricultural practices has led to a significant decline in soil health on a global scale. Intensive cultivation, excessive use of chemical fertilizers and pesticides, and inadequate crop rotation have resulted in soil degradation, erosion, and loss of vital nutrients. These practices, driven by the need to feed a growing population, have led to compaction, reduced organic matter content, desiccation and desertification and increased susceptibility to erosion. The resulting decline in soil quality threatens food security, ecosystem resilience, and the long-term sustainability of agricultural systems worldwide. All this accelerates climate change.

Improving soil quality includes improving on, or increasing, one or more of the following factors: increasing the carbon content or organic matter level of the soil; increasing nutrient content (such essential elements like nitrogen, phosphorus, and potassium) in a balanced manner; improving soil aeration; improving soil structure; improving moisture retaining capacity; and improving beneficial microbial activity in the soil.

The present invention at least partially addresses the problem.

### SUMMARY OF INVENTION

In this context, “biochar” signifies a stable carbon-rich solid formed via organic feedstock pyrolysis, where the process minimizes gas and liquid phases while maximizing solid phase formation.

In this context, “activated carbon” refers to a porous carbon material produced by heating carbon-rich feedstock with a non-oxygen gas, creating its highly porous structure.

In accordance with the invention there is provided a nutritional soil conditioning formulation (mixture) which includes:
a) particulates of igneous rock;
b) particulates of a carbon source; and
c) a binding agent to bind together the particulates of igneous rock and the carbon source.

The carbon source may be adapted for one of the following functions: to sequester carbon (carbon dioxide) and as an absorbent.

The carbon source may be at least one of the following: biochar and activated carbon.

The biochar or activated carbon may be derived from at least one of the following: wood; tree biomass such as, for example, bark, needles, sawdust, leaves; coconut shells; nut shells; and recycled forms of the same, for example wooden pallet scrap.

The igneous rock may belong to one or more of the following rock types: basalt, mafic, ultramafic (such as kimberlite), and olivine.

Preferably the igneous rock is an ultramafic rock.

The igneous rock may have a silicon oxide (SiO₂) content below 50% (w/w).

Preferably, the SiO₂ content is below 45% (w/w).

The binding agent may be sodium lignosulfonate, potassium lignosulfonate, molasses, dextrose, guar gum, xanthan gum or carboxy methyl cellulose.

Preferably, the binding agent is sodium lignosulfonate.

The particulates of igneous rock may be sized below 150 μm.

The particulates of the carbon source may be sized below 150 μm.

Preferably, the particle size distribution of the particulates of the carbon source is between 2 μm and 150 μm.

The formulation may be compressed (pelletized) into a plurality of pellets.

Each pellet may be compressed to achieve a specific gravity with reference to water in the range of 0.5 to 2. A specific gravity of 1 is preferred.

Each pellet may be between 1-5 mm in diameter. Preferably, each pellet is 2 to 4 mm in diameter.

The nutritional soil conditioning formulation may contain between 1 and 99% particulates of igneous rock.

The nutritional soil conditioning formulation may be comprised of between 70% to 95% particulates of igneous rock.

Preferably, the nutritional soil conditioning formulation may be comprised of between 80% to 90% particulates of igneous rock.

More preferably, the nutritional soil conditioning formulation may be comprised of 87.5% particulates of igneous rock.

The nutritional soil conditioning formulation may be comprised of between 1% and 99% particulates of the carbon source.

Preferably, the nutritional soil conditioning formulation may be comprised of between 5% and 20% particulates of the carbon source.

More preferably, the soil conditioning formulation may be comprised of 10% particulates of the carbon source.

More preferably, the nutritional soil conditioning formulation may be comprised of 87.5% particulates of igneous rock, 10% particulates of the carbon source and 2.5% binding agent.

### BRIEF DESCRIPTION OF THE DRAWINGS

The invention is further described by way of an example with reference to the accompanying drawings in which:

FIG. 1 is a flow diagram illustrating a method of manufacturing a nutritional soil conditioning formulation in accordance with the invention;

FIG. 2 graphically depicts the outcome of a plant height assessment on wheat plants after the application of the nutritional soil conditioning formulation in accordance with the invention;

FIG. 3 graphically depicts the outcome of a wet biomass assessment on wheat after the application of the nutritional soil conditioning formulation;

FIG. 4 graphically depicts the outcome of a dry biomass assessment on wheat after the application of the nutritional soil conditioning formulation;

FIG. 5 graphically depicts the outcome of a wet biomass assessment on beans after the application of the nutritional soil conditioning formulation; and

FIG. 6 graphically depicts the outcome of a plant height assessment on beans after the application of the nutritional soil conditioning formulation.

### DESCRIPTION OF PREFERRED EMBODIMENTS

In accordance with the patent specification style, the description of the process for manufacturing pellets of a nutritional soil conditioning formulation can be presented as follows.

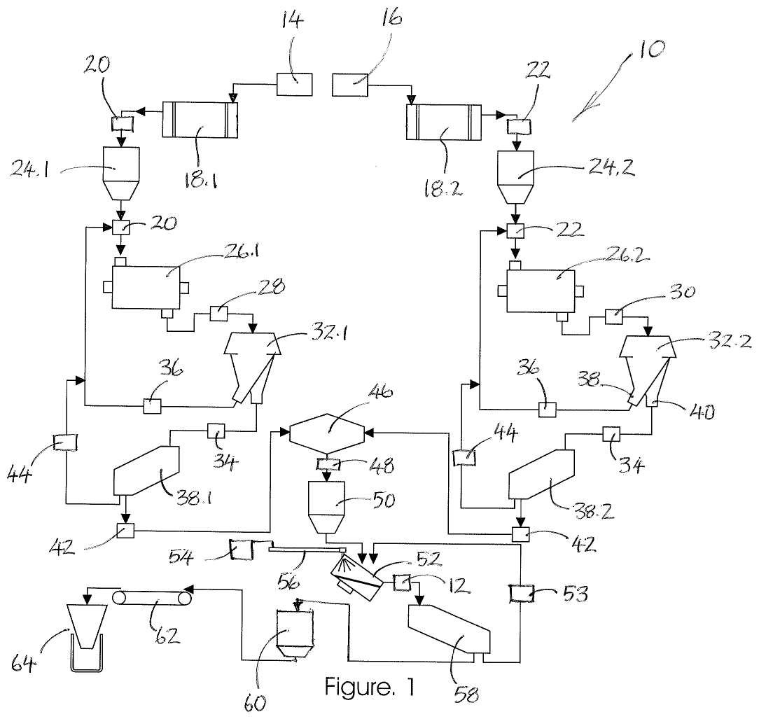

FIG. 1 illustrates a process 10 for manufacturing pellets of a nutritional soil conditioning formulation 12 which accords with the invention.

In an initial stage, designated as the first step, raw materials consisting of rock dust and a carbon source (referred to as 14 and 16, respectively) are subjected to drying processes within individual dryers (18.1 and 18.2), achieving a moisture content of 2% (w/w).

In this particular example, Biochar is used as the carbon source.

In a subsequent step, the dried particles from each of the aforementioned raw material feeds (20 and 22) are reduced to a maximum size of 150 μm through milling or grinding processes. The dry particles from each raw material feed (20 and 22) are temporarily stored within dedicated hoppers (24.1 and 24.2) before being fed to the milling or grinding process.

The grinding procedure may be executed as dry grinding, rod milling or ball milling or dry jet milling, or dry crushing, encompassing mechanical methods wherein mineral particles are subjected to forces of crushing or grinding to attain reduced dimensions. Various equipment options are available, such as ball mills, hammer mills, or rod mills. Jet milling, a specialized dry grinding technique utilizing high-speed compressed air or inert gases to impact and size-reduce mineral particles, is also viable. Dry crushing involves feeding the raw material into a crushing chamber, where compression or impact forces bring about size reduction.

In this particular example, a dry grinding process is chosen, with both the rock dust and Biochar feeds (20 and 22) being introduced into a respective rod mill (26.1, 26.2) through an inlet.

For ease of comprehension, this explanation focuses solely on the processing of rock dust; however, the forthcoming elucidation is equally applicable to the processing of the alternative raw material, Biochar.

In the third step, which comprises size separation, the output originating from the ball mill, representing milled rock dust and Biochar feeds (28 and 30), is subsequently directed to corresponding air classifiers (32.1 and 32.2). These classifiers are responsible for the separation of a fines stream 34 from a coarse stream 36.

The classifier operation hinges on subjecting the particle mixture to a regulated airflow within the classifier's separation chamber. As the mixture traverses the chamber, centrifugal and gravitational forces come into play, acting on particles based on their size and density. This precise and efficient particle size separation is orchestrated through adjustable parameters such as airflow velocity and rotor speed.

Larger and denser particles migrate towards the outer periphery of the chamber, eventually being collected within the coarse stream 34. This stream exits the classifier via outlet 38 and is reintroduced as input into the ball mill 26. Conversely, smaller, and lighter particles are directed towards the centre, forming the fine stream, which exits the classifier through outlet 40.

The fines stream can be subjected to another size separation operation, this time via dry screening, achieved by passage over or through a vibratory or shaker sieve system (38.1 and 38.2). This secondary process ensures that all particles passing through the system constitute an undersized fraction 42, with particle sizes not exceeding 150 μm. Any particles surpassing the 150 μm threshold exit the sieve system as an oversized fraction 44, which, akin to the coarse stream from the prior separation step, is reintegrated as input into the ball mill 26.

The undersized fraction 42 of both the rock dust and Biochar raw material streams is amalgamated in the fourth step.

A blend formulation is achievable through the utilization of diverse blender types (46), for example ribbon blenders, tumble blenders, paddle blenders, fluidized bed blenders, cone screw blenders, or rotary drum blenders.

The resultant output from the blender, designated as feedstock 48, is retained within a hopper 50.

The further step, a spheroidization or pelletization stage, ensues.

To effectuate the transformation of the fine feedstock 48 into round pellets falling within the specified size range of 2 to 4 mm, the process employs either a fluidized bed pelletizer, a pan pelletizer or a pelletizing and granulating technique which includes a moving bed with a paddle traversing in an opposite direction to create a rolling effect. Using a fluidized bed pelletizer, fine feedstock particles are suspended and fluidized within an air or gas stream within a bed.

A binder solution 54, comprising sodium or potassium lignosulfonate in this instance, is dispensed onto the fluidized particles by means of a spray bar 56. The binder's contact with the particles induces agglomeration or pellet formation.

The fluidized bed configuration facilitates uniform distribution of the binder. Further, control over airflow and temperature is influential in governing the drying and pelletization process.

Alternatively, the pan or disk pelletizer variant 52 is employed, as illustrated herein. It incorporates a rotating disc or pan furnished with a central spray bar 56 for the application of binder solution 54. The fine feedstock 48 is introduced onto the pan's surface, and the binder is distributed onto the material as it undergoes agitation and tumbling within the pan.

The rotational motion of the pan plays a role in aggregating the feedstock particles into round pellets. Pellet size is subject to control by adjusting the disc's speed, the pan's angle, and the rate of binder application.

The outcome of this process predominantly comprises pellets falling within the specified size range of 2 to 4 mm, a range that is achieved by adjustment of process parameters and the binder composition. The resulting pellets 12, which constitute the nutritional soil conditioning formulation, display a rounded or spherical morphology.

Subsequent to pellet formation, the pellets 12 undergo a sorting stage to ensure they fall within the optimal size range of 2 to 4 mm. This entails passage over or through a secondary vibratory sieve 58. Pellets smaller than 2 mm (53) are subjected to recycling into the pan pelletizer 52 for reprocessing, while pellets larger than 4 mm may undergo a crushing operation (unillustrated) prior to recycling.

The pellets 12, now falling within the target size range of 2 to 4 mm, are ultimately stored within a hopper 60, awaiting batch-wise release, whereupon they are weighed on a weigh conveyor 62 and subsequently fed into a bagging machine 64 for packaging purposes.

In this manner, the described process achieves the manufacture of pellets conforming to specific size and quality requirements for a nutritional soil conditioning formulation.

### Benefits

The resultant pellets 12 are composed entirely of carbon and rock dust with a binder. Traditional carbon sources such as biochar are notorious for their lightweight properties, susceptibility to dust generation, and the inherent difficulties associated with handling and application. In stark contrast, the pellets originating from the innovation disclosed herein are mostly devoid of dust particles and are characterized by exceptional ease of application.

A core feature of the invention's formulation is its surprisingly profound capacity to enhance soil health and augment water retention within the soil matrix as will be seen when describing use of the formulation in the examples that follow. This is primarily achieved through the pellets' ability to facilitate water absorption and the retention and controlled release of crucial nutrients and moisture within the soil structure.

The nutritional soil conditioning formulation is a natural soil conditioner comprising a high-surface-area biomass Biochar and ultramafic rock dust. Upon contact with water, the binders within the formulation dissolve, thereby freeing micro-fine particles to the soil and to the various soil microorganisms that live therein.

The exposed micro-fine particles mineralize the soil by infusing essential micro-elements such as calcium, magnesium, iron, silica, copper, and zinc into the soil matrix. Notably, the pellets closely resemble granular fertilizers in terms of size, shape, and weight, consequently enabling the formulation to be broadcast with NPK (Nitrogen, Phosphorus, Potassium), reducing the amount of such fertilizers with concomitant economic and environmental benefit.

More specifically, aligning with the worldwide objective of diminishing nitrogen utilization and the resulting release of NO₂, which affects the environment as a greenhouse gas, the utilization of this particular product directly diminishes the historical nitrogen requirement for a specific yield. Consequently, it enables the attainment of equivalent or superior yields with a reduced carbon footprint and cost savings.

The chosen ultramafic rock has the following typical major mineral profile:

TABLE 1

| Mineral | Weight (w/w) % |
|---|---|
| Silicon oxide (SiO₂) | 48.58 |
| Titanium oxide (TiO₂) | 0.91 |
| Aluminium oxide (Al₂O₃) | 16.32 |
| Ferric oxide (Fe₂O₃) | 9.30 |
| Manganese oxide (MnO) | 0.18 |
| Magnesium oxide (MgO) | 6.36 |
| Calcium oxide (MgO) | 12.11 |
| Sodium oxide (Na₂O) | 2.32 |
| Potassium oxide (K₂O) | 0.58 |
| Phosphorous oxide (P₂O₅) | 0.15 |
| Chromium oxide (Cr₂O₃) | 0.02 |

In addition, the ultramafic rock has a trace element profile consisting of the following elements beneficial to plants: boron (≤50 ppm), copper (65 ppm), zinc (68 ppm), nickel (89 ppm), molybdenum (1.9 ppm), and silver ≤2 ppm).

When Biochar is added, it lowers the concentrations of certain components found in ultramafic rocks. By incorporating 10% (by weight) Biochar, the silica concentration in the soil conditioner mix is brought down to about 45%, which is a favoured level for this particular element. Nevertheless, it's possible to adjust the Biochar concentration to create a formulation tailored to a specific objective.

An attribute of the invention is its ability to sequester carbon within the soil for an extended duration, making the formulation an important contributor in climate change mitigation efforts. This is predicated on the formulation's dual capability to capture atmospheric CO₂ and substantially increase carbon storage levels within the soil. The amplification of carbon content, microbial activity, and the production of micronutrients through this process can lead to a decrease in the necessity for chemical fertilizers, including common options like NPK and MAP, with a particular emphasis on nitrogen-based sources. This reduction mitigates the adverse consequences associated with excessive nitrogen usage, such as the generation of harmful NO₂ emissions and the contamination of water systems through runoff and leaching.

The soil conditioning formulation, in its pelletized form (each pellet falling within the target size range of 2 to 4 mm), is applied to a crop to improve, relatively to a crop that to which a standard monoammonium phosphate (MAP) fertilizer protocol, at least one of the following attributes: vigour, plant height, biomass, emergence and chlorophyll content. Due to the size of the pellets, the formulation can be applied to the crop via a mechanical fertilizer spreader. The preferred application rate for the soil conditioning formulation is 400 to 800 kg per hectare, either mixed with MAP or used independently. An economic advantage of the soil conditioning formulation is its ability to serve as a dilution agent for MAP application, resulting in a cost reduction for the fertilizer program while still preserving or enhancing the health and vitality of the intended crop.

### Example 1

To determine the effect of the nutritional soil conditioning formulation (hereinafter referred to as the soil conditioner), in accordance with the invention, on plant growth and yield, a first series of treatments in a trial conducted on wheat (Triticum aestivum) in a growth chamber situated on the premises of ApeiroAG on Groenfontein farm in the Klapmuts region of the Western Cape, South Africa.

The treatments, as summarised in Table 1 below, were initiated by sowing on 5 Apr. 2023. Treatment 1 is the untreated control, Treatment 2 is a carbon only treatment, Treatments 3 to 8 are soil conditioner only treatments, Treatments 9 to 14 are mixed soil conditioner and MAP treatments, and Treatment 15 is an MAP only treatment.

TABLE 1

| Treatment | | | |
|---|---|---|---|
| number | Treatment type | Rate | Rate unit |
| 1 | Control | — | |
| 2 | Carbon only | 1 | % v/v |
| 3 | Soil conditioner only | 25 | kg/ha |
| 4 | Soil conditioner only | 50 | kg/ha |
| 5 | Soil conditioner only | 100 | kg/ha |
| 6 | Soil conditioner only | 200 | kg/ha |
| 7 | Soil conditioner only | 400 | kg/ha |
| 8 | Soil conditioner only | 800 | kg/ha |
| 9 | Soil conditioner | 5/95 | kg/ha |
| | 5%/MAP 95% | | |
| 10 | Soil conditioner | 10/90 | kg/ha |
| | 10%/MAP 90% | | |
| 11 | Soil conditioner | 15/85 | kg/ha |
| | 15%/MAP 85% | | |
| 12 | Soil conditioner | 20/80 | kg/ha |
| | 20%/MAP 80% | | |
| 13 | Soil conditioner | 40/60 | kg/ha |
| | 40%/MAP 60% | | |
| 14 | Soil conditioner | 50/50 | kg/ha |
| | 50%/MAP 50% | | |
| 15 | MAP 100% | 100 | kg/ha |

Assessments for the parameters of emergence vigour, plant height, wet and dry biomass and chlorophyll content were done during the trial at parameter specific intervals post sowing.

Emergence—the majority of the wheat seeds that were planted per pot (4 seeds) had emerged by 7 DA-A, with the exception of Treatments 2, 3 and 11 that only had 3 emerged plants. By 10 DA-A all wheat plants had emerged. None of the treatments statistically differed from each other in terms of emergence.

Viqour—at 7 DA-A and 10 DA-A, all treatments including the untreated control did not statistically differ from each other and had 100% vigour.

At 28 DA-A: Treatments 7 and 11 were statistically the most vigorous at 122.5% and 120.17% respectively. Treatments 2, 3, 6 and 13 were the least vigorous (101.83%-103.33%), where only Treatment 3 statistically differed from the untreated control (100%). Treatments 5, 8-10, 12 and 15 had vigour between 112.33% and 113.33% and did not statistically differ from each other. Treatment 4 had 109.83% vigour and Treatment 14 had 106.33% vigour, where both treatments statistically differed from each other and all other treatments.

At 42 DA-A: Treatment 7 was statistically the most vigorous at 123.33% followed by Treatment 11 (120.83%), where both treatments statistically differed from all other treatments.

Treatments 2, 3, 6 and 13 were the least vigorous (102.17%-104.17%), where only Treatment 6 did not statistically differ from the untreated control (100%). Treatments 5, 8-10, 12 and 15 had vigour between 112.5% and 114.5% and did not statistically differ from each other, where Treatments 5, 8 and 15 did not statistically differ from Treatment 4 (110.67%). Treatment 14 had 106.67% vigour and statistically differed from all other treatments.

Plant height—at 28 DA-A, none of the treatments statistically differed from each other or the untreated control (16.33 cm) and had average plant height between 14.83 cm (Treatments 13 and 14) and 17.33 m (Treatment 2).

At 42 DA-A, Treatments 5 and 7 had the highest average plant height at 20.67 cm each and did not statistically differ from each other or from Treatments 2-4, 8, 9, 11, 12, 14 and 15 (17.92 cm-20.58 cm). Treatments 6, 10 and 13 had average plant height between 17.08 cm and 17.83 cm and did not statistically differ from each other or from Treatments 4, 8, 11, 12, 14, 15 and the untreated control (16.92 cm). Treatment 6 did not statistically differ from Treatments 2, 3 and 9, and Treatment 10 did not statistically differ from Treatment 9.

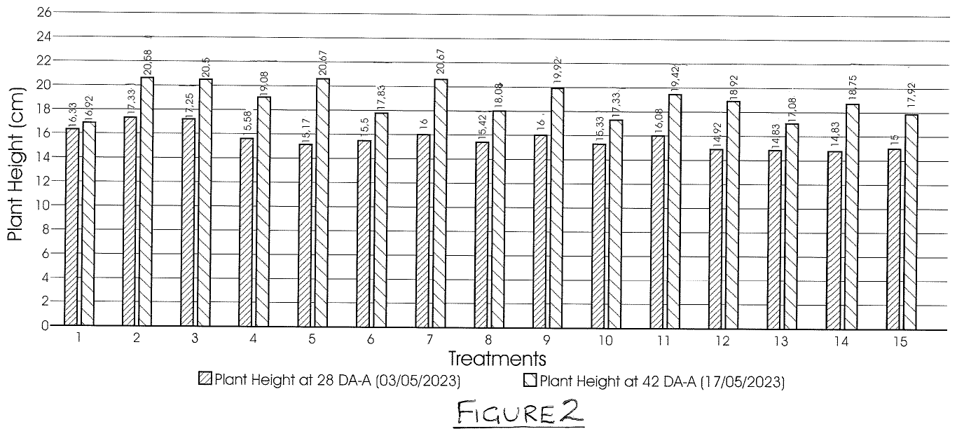

FIG. 2 graphically depicts the outcome of the plant height assessment as summarised above.

Wet biomass—at 50 DA-A, Treatment 7 had the heaviest above ground (16.85 g) and root (21.88 g) mass, where the untreated control had the lowest above ground (6.37 g) and root (3.79 g) mass. Treatments 3-6 and 8 had above ground mass between 10.81 g and 14.63 g and root mass between 8.58 g and 12.71 g. Treatments 9-13 had above ground mass between 9.56 g and 5.39 g and root mass between 10.33 g and 18 g. Treatment 2 had above ground mass at 12.01 g and root mass at 8.56 g. Treatments 14 and 15 had above ground mass at 10.16 g and 14.21 g respectively and root mass at 17.02 g and 14.52 g respectively. Total wet mass was between 21.6 g and 38.73 g for Treatments 3-8, between 21.39 g and 33.39 g for Treatments 9-13, and between 20.57 g and 28.78 g for Treatments 2, 14 and 15.

Dry biomass—at 57 DA-A, Treatment 9 had the highest above ground mass at 4.42 g (root mass: 6.86 g) and Treatment 8 had the highest root mass at 7.82 g (above ground mass: 4.42 g), where the untreated control had the lowest above ground (1.94 g) and root (2.54 g) mass.

Treatments 3-7 had above ground mass between 3.41 g and 4.63 g and root mass between 3.35 g and 5.37 g. Treatments 10-13 had above ground mass between 3.47 g and 4.16 g and root mass between 3.97 g and 5.52 g. Treatment 2 had above ground mass at 4.07 g and root mass at 3.85 g. Treatments 14 and 15 had above ground mass at 3.84 g and 3.35 g respectively and root mass at 6.37 g and 5.37 g respectively. Total dry weight was between 7.4 g and 12.24 g for Treatments 3-8, between 7.44 g and 11.63 g for Treatments 9-13, and between 7.92 g and 10.21 g for Treatments 2, 14 and 15.

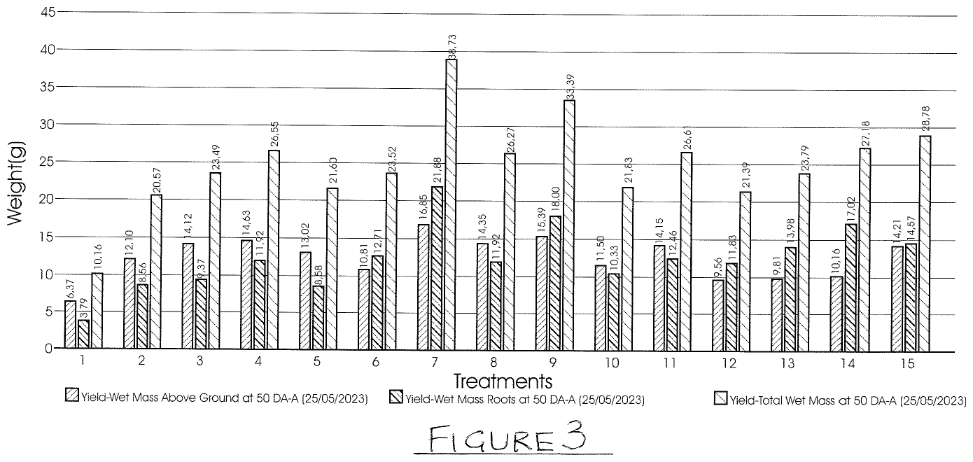

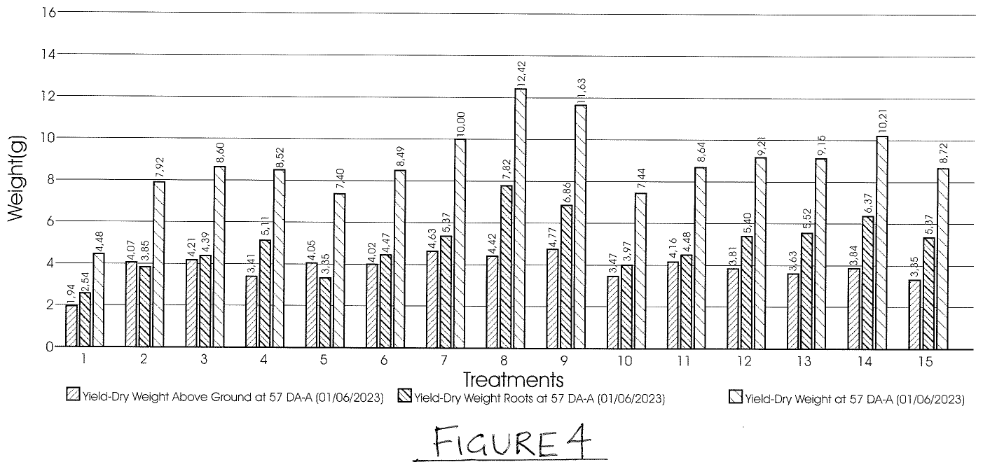

FIGS. 3 and 4 graphically depicts the outcome of the wet biomass and the dry biomass assessment respectively as summarised above.

Chlorophyll content—at 28 DA-A, Treatment 5 had the highest Chlorophyll Index at 28.380 index units but did not statistically different from Treatments 3, 4, 6-12, 14 and 15 (21.838-27.769 index units). Treatments 2 and 13 had the lowest Chlorophyll Index at 21.297 and 19.781 index units respectively and did not statistically differ from each other or from Treatments 4, 6-10, 12 and 14 or the untreated control (15.621 index units). Treatment 2 also did not statistically differ from Treatments 3 and 11.

### Example 2

To determine the effect of the soil conditioner, in accordance with the invention, on plant growth and yield, a second series of trial treatments was conducted on beans (Phaseolus vulgaris) on the same premises a described above.

The treatments, as summarised in Table 2 below, were initiated by sowing on 8 Jun. 2023.

TABLE 2

| Treatment | | | |
|---|---|---|---|
| number | Treatment type | Rate | Rate unit |
| 1 | Control | — | |
| 2 | MAP only | 50 | kg/ha |
| 3 | MAP only | 100 | kg/ha |
| 4 | Soil conditioner/MAP | 50/50 | kg/ha |
| 5 | Soil conditioner/MAP | 100/50 | kg/ha |
| 6 | Soil conditioner/MAP | 200/50 | kg/ha |
| 7 | Soil conditioner/MAP | 400/50 | kg/ha |
| 8 | Soil conditioner/MAP | 800/50 | kg/ha |
| 9 | Soil conditioner/MAP | 50/100 | kg/ha |
| 10 | Soil conditioner/MAP | 100/100 | kg/ha |
| 11 | Soil conditioner/MAP | 200/100 | kg/ha |
| 12 | Soil conditioner/MAP | 400/100 | kg/ha |
| 13 | Soil conditioner/MAP | 800/100 | kg/ha |
| 14 | Soil conditioner/MAP | 100/10/50 | kg/ha |
| 15 | Soil | 200/20/50 | kg/ha |
| | conditioner/Hydrocache/MAP | | |
| 16 | Soil | 400/40/50 | kg/ha |
| | conditioner/Hydrocache/MAP | | |
| 17 | Soil | 800/80/50 | kg/ha |
| | conditioner/Hydrocache/MAP | | |

Hydrocache™ is a moisture retaining carbon enriched gel that is worked into the soil to hold on to moisture to be absorbed by a plant when needed.

As with the first example, assessments for the parameters of emergence, vigour, plant height, wet and dry biomass, and chlorophyll content were conducted during the trial at parameter specific intervals post sowing.

None of the treatments showed any statistical difference in vigour from the untreated control (100%) for the duration of the trial. Neither did any of the treatments statistically differ in plant height from each other or the untreated at 21 and 36 DA-A. As for emergence, at 7 DA-A, none of the seeds (1 seed per pot) had emerged for the treatments or the untreated control. At 11 DA-A, only Treatment 4 had no emerged plant and by 15 DA-A, all treatments and the untreated control had an emerged plant. However, it is in terms of biomass that the most significant differences are observed among plants treated with the soil conditioning agent, the control group, and the plants treated with MAP

Wet Biomass—at 36 DA-A: Treatment 12 had the heaviest above ground mass (42 g), and Treatment 8 had the heaviest root mass (44 g) mass. Treatment 17 had the lowest above ground mass (21.6 g) and Treatments 4 and 13 had the lowest root mass (24 g each). Treatments 4-8 had above ground mass between 25 g and 36 g and Treatments 5-7 had root mass between 30 g and 38.4 g. Treatments 9-11 and 13 had above ground mass between 25 g and 35 g and Treatments 9-12 had root mass between 32 g and 36 g. Treatments 14-16 had above ground mass between 30 g and 36 g and Treatments 14-17 had root mass between 25.2 g and 35 g. Treatments 2 and 3 had above ground mass at 34 g and 30 g respectively and root mass at 33 g and 27 g respectively. Total wet mass was between 52.5 g and 76 g for Treatments 4-8, between 57 g and 77 g for Treatments 9-12, between 49.2 g and 71 g for Treatments 14-17, and 67 g and 57 g respectively for Treatments 2 and 3.

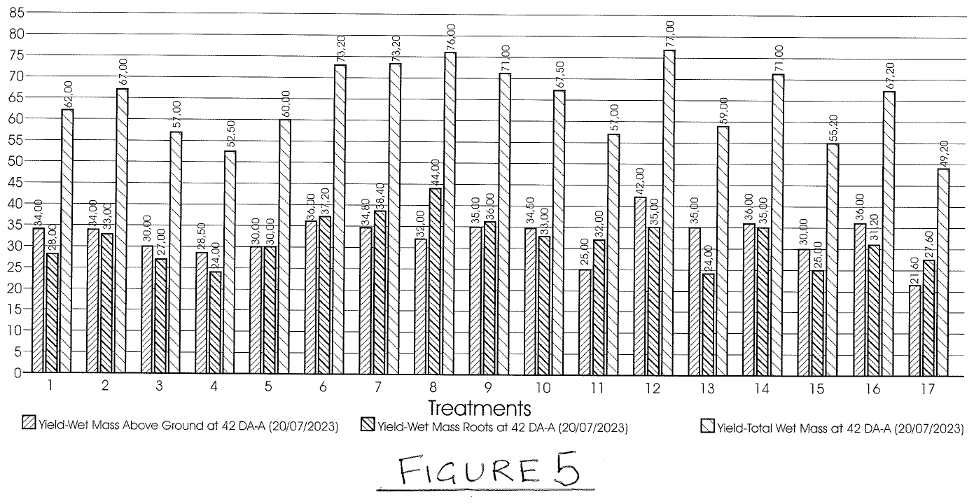

FIG. 5 graphically depicts the outcome of the wet biomass assessment as summarised above.

Dry biomass—the untreated control had the heaviest above ground mass (9.12 g) followed by Treatment 17 (8.92 g) and Treatment 8 had the heaviest root mass (13.61 g). Treatment 4 had the lowest above ground mass (4.68 g) and Treatment 13 had the lowest root mass (5.43 g). Treatments 5-8 had above ground mass between 5.1 g and 8.04 g and Treatments 4-7 had root mass between 10.21 g and 13.27 g. Treatments 9-13 had above ground mass between 7.09 g and 8.46 g and Treatments 9-12 had root mass between 7.4 g and 9.01 g. Treatments 14-16 had above ground mass between 5.08 g and 8.35 g and Treatments 14-17 had root mass between 9.43 g and 12.81 g. Treatments 2 and 3 had above ground mass at 7.09 g and 6.16 g respectively and root mass at 7.37 g and 9.32 g respectively. Total dry weight was between 15.89 g and 20.89 g for Treatments 4-8, between 12.52 g and 16.5 g for Treatments 9-12, between 14.51 g and 20.63 g for Treatments 14-17, and 14.46 g and 15.48 g respectively for Treatments 2 and 3.

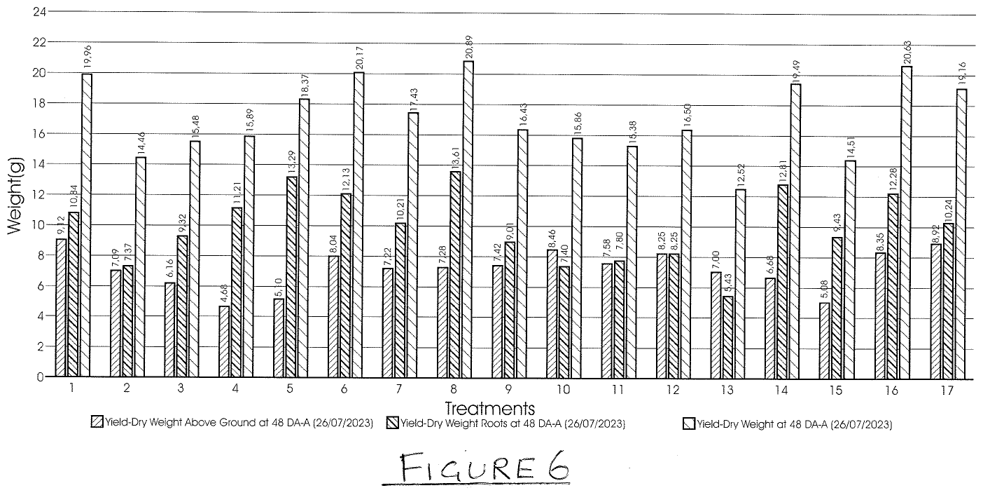

FIG. 6 graphically depicts the outcome of the dry biomass assessment as summarised above.

No physical compatibility problems i.e., separation, foaming or sedimentation etc. were observed with any of the compounds for the duration of the trial. The wheat plants were carefully inspected for phytotoxicity symptoms, e.g., discolouration (chlorosis or yellowing), necrosis, scorching, stunting and/or deformities. No signs of phytotoxicity were observed in any of the treated plots for the duration of the trial. According to the data in this trial, all treatments can be considered safe to use on, at least, wheat and beans.

1. A nutritional soil conditioning formulation which includes:
(a) particulates of igneous rock;
(b) particulates of a carbon source; and
(c) a binding agent to bind together the particulates of igneous rock and the carbon source.

2. A nutritional soil conditioning formulation according to claim 1 wherein the carbon source is configured to sequester carbon or as an absorbent.

3. A nutritional soil conditioning formulation according to claim 1 or 2 wherein the carbon source is at least one of the following: biochar and activated carbon.

4. A nutritional soil conditioning formulation according to claim 3 wherein the biochar or activated carbon is derived from at least one of the following: wood, tree biomass, coconut shells and nut shells.

5. A nutritional soil conditioning formulation according to any one of claims 1 to 4 wherein the igneous rock belongs to one or more of the following rock types: basalt, mafic, ultramafic and olivine.

6. A nutritional soil conditioning formulation according to claim 5 wherein the igneous rock is ultramafic.

7. A nutritional soil conditioning formulation according to claim 5 or 6 wherein the igneous rock has a silicon oxide content below 50% (w/w).

8. A nutritional soil conditioning formulation according to claim 7 wherein the silicon oxide content is below 45% (w/w).

9. A nutritional soil conditioning formulation according to any one of claims 1 to 8 wherein the binding agent is sodium lignosulfonate, potassium lignosulfonate, molasses, dextrose, guar gum, xanthan gum or carboxy methyl cellulose.

10. A nutritional soil conditioning formulation according to claim 9 wherein the binding agent is sodium lignosulfonate.

11. A nutritional soil conditioning formulation according to any one of claims 1 to 10 wherein the particulates of igneous rock are sized below 150 μm.

12. A nutritional soil conditioning formulation according to any one of claims 1 to 11 wherein the particulates of the carbon source are sized below 150 μm.

13. A nutritional soil conditioning formulation according to any one of claims 1 to 12 wherein the formulation is compressed into a plurality of pellets.

14. A nutritional soil conditioning formulation according to claim 13 wherein each pellet is compressed to achieve a specific gravity with reference to water in the range of 0.5 to 2.

15. A nutritional soil conditioning formulation according to claim 14 wherein each pellet is compressed to achieve a specific gravity with reference to water of 1.

16. A nutritional soil conditioning formulation according to any one of claims 13 to 15 wherein each pellet has a diameter between 1-5 mm in diameter.

17. A nutritional soil conditioning formulation according to claim 16 wherein each pellet has a diameter between 2-4 mm.

18. A nutritional soil conditioning formulation according to any one of claims 1 to 17 which contains between 1% and 99% particulates of igneous rock.

19. A nutritional soil conditioning formulation according to claim 18 which contains 87.5% particulates of igneous rock.

20. A nutritional soil conditioning formulation according to any one of claims 1 to 19 which contains between 1% and 99% particulates of the carbon source.

21. A nutritional soil conditioning formulation according to claim 20 which contains between 10% particulates of the carbon source.

22. A nutritional soil conditioning formulation according to claim 1 More preferably, the nutritional soil conditioning formulation may be comprised of 87.5% particulates of igneous rock, 10% particulates of the carbon source and 2.5% binding agent.
